(19) United States
(12) Patent Application Publication
(10) Pub. No.: US 2011/0128398 A1
(43) Pub. Date: Jun. 2, 2011

(54) Image Processing Apparatus, Image Processing Method, and Computer Program

(75) Inventor: Masato Shimodaira, Osaka (JP)

(73) Assignee: KEYENCE CORPORATION, Osaka (JP)

(21) Appl. No.: 12/943,377

(22) Filed: Nov. 10, 2010

(30) Foreign Application Priority Data
Dec. 1, 2009 (JP) 2009-273983

(51) Int. Cl. H04N 5/228

(52) U.S. Cl. 348/222.1; 348/E05.031

(57) ABSTRACT

In the case of executing image processing on a multivalued image obtained by picking up an image of an imaging object with a camera, the invention calculates a predetermined projective transformation parameter for projectively transforming a multivalued image before image processing, calculates a projected area obtained by projectively transforming an area where pixels of the multivalued image before image processing exist to an output area where pixels of a multivalued image after image processing exist based upon the calculated projective transformation parameter, specifies as an effective area an area in which the calculated projected area is overlapped with the output area where the pixels of the multivalued image after image processing exist, and performs coordinate transformation based upon the specified effective area and the calculated projective transformation parameter, to generate the multivalued image after image processing from the multivalued image before image processing.

### CROSS-REFERENCE TO RELATED APPLICATIONS

The present application claims foreign priority based on Japanese Patent Application No. 2009-273983, filed Dec. 1, 2009, the contents of which is incorporated herein by reference.

### BACKGROUND OF THE INVENTION

1. Field of the Invention

The present invention relates to an image processing technology for projectively transforming a multivalued image picked up by an imaging device to correct perspective distortion of the multivalued image.

2. Description of Related Art

Conventionally, in apparatuses for picking up an image of a test object with an imaging device to inspect the test object and detect a defect thereof by use of the picked-up multivalued image, a variety of perspective distortion has occurred in accordance with a positional relation between the test object and the imaging device, a configuration of a lens, and the like. In many apparatuses, the picked-up multivalued image is appropriately projectively transformed for preventing deterioration in accuracy of inspection on the test object, accuracy of defect detection, and the like, to correct perspective distortion included in the multivalued image. By appropriately performing projective transformation, perspective distortion that occurs in accordance with the positional relation between the test object and the imaging device can be corrected.

For example, in Japanese Unexamined Patent Publication No. 2006-074512, a rectangle being an external form of a pedestal whose shape is well known is regarded as a reference polygon, and the rectangle as the reference polygon is compared with a rectangle specified by a contour of a pedestal image, to obtain a projective correction parameter. Using the obtained projective correction parameter, a multivalued image picked up by a camera is projectively transformed for correction.

### SUMMARY OF THE INVENTION

Generally, in the case of projectively transforming a multivalued image, a multivalued image before transformation and a multivalued image after transformation are different from each other in an area where pixels exist. Namely, even in an area where pixels exist in the multivalued image before transformation, pixels may not exist in the multivalued image after transformation, or the reverse case may also take place. Therefore, when an area where pixels do not exist in the multivalued image before transformation is projectively transformed, pixels of the corresponding area in the multivalued image after transformation are made black.

However, when the entire image after transformation is intended to be obtained in the conventional image processing apparatus, even in the case of the black pixels existing in the multivalued image after transformation, projective transformation itself is performed by conducting coordinate transformation calculation of every pixel point by point to find a portion of the multivalued image before transformation, to which each pixel in the multivalued image after transformation corresponds. There has thus been a problem in that it is difficult to reduce processing time, so as to complete image processing at high speed.

Further, in the case of a multivalued image with a distant background appearing therein other than the imaging object and large perspective distortion of the multivalued image of the imaging object, there has also been a problem in that an unnecessary multivalued image (virtual image), whose polarity based upon a predetermined condition for projective transformation is a reverse polarity, might be included other than an image as an object to be transformed by projective transformation.

The present invention relates to an image processing apparatus capable of reducing processing time and also suppressing appearance of a virtual image in the case of projectively transforming a multivalued image, an image processing method used in the image processing apparatus, and a computer program for causing a computer to execute processing in the image processing method.

According to one embodiment of the present invention, there is provided an image processing apparatus, which executes image processing on a multivalued image obtained by picking up an image of an imaging object with an imaging device, the apparatus including: a projective transformation parameter calculating device for calculating a predetermined projective transformation parameter for projectively transforming a multivalued image before image processing to correct perspective distortion; a projected area calculating device for calculating a projected area, obtained by projectively transforming an area where pixels of the multivalued image before image processing exist to an output area where pixels of a multivalued image after image processing exist, based upon the projective transformation parameter calculated by the projective transformation parameter calculating device; an effective area specifying device for specifying as an effective area an area in which the projected area calculated by the projected area calculating device is overlapped with the output area where the pixels of the multivalued image after image processing exist; and an image transforming device for performing coordinate transformation based upon the effective area specified by the effective area specifying device and the projective transformation parameter calculated by the projective transformation parameter calculating device, to generate the multivalued image after image processing from the multivalued image before image processing.

Further, according to another embodiment of the present invention, the image processing apparatus includes a shape information input accepting device for accepting an input of shape information that specifies shapes of the imaging object before image processing and after image processing on the multivalued image, wherein the projective transformation parameter calculating device calculates the projective transformation parameter based upon the shape information the input of which has been accepted by the shape information input accepting device.

Further, according to another embodiment of the present invention, the image processing apparatus includes an image displaying device for displaying the multivalued image, wherein the shape information input accepting device accepts the input of the shape information that specifies shapes of the imaging object before image processing and after image processing on the multivalued image before image processing displayed in the image displaying device.

Further, according to another embodiment of the present invention, in the image processing apparatus, the image displaying device is provided with a display switching device for switching and displaying the multivalued image before image processing, the multivalued image after image processing, and the shape information the input of which has been accepted by the shape information input accepting device.

Further, according to another embodiment of the present invention, the image processing apparatus includes a transformation target area setting device for setting as a transformation target area a predetermined area including specific pixels in the area where the pixels of the multivalued image before image processing exist, wherein the projected area calculating device calculates the projected area, obtained by projectively transforming the transformation target area set by the transformation target area setting device, based upon the projective transformation parameter calculated by the projective transformation parameter calculating device.

Further, according to another embodiment of the present invention, in the image processing apparatus, the transformation target area setting device sets the predetermined area including specific pixels as the transformation target area out of areas divided by a predetermined straight line defined based upon the projective transformation parameter.

Further, according to another embodiment of the present invention, in the image processing apparatus, the transformation target area setting device sets, as the transformation target area, a predetermined area including pixels that exist inside the shape of the imaging object, the shape being specified by the shape information the input of which has been accepted by the shape information input accepting device.

Further, according to another embodiment of the present invention, in the image processing apparatus, the transformation target area setting device has: a first intersection calculating device for calculating a first intersection at which a predetermined straight line defined based upon the projective transformation parameter is intersected with an outer circumferential line of the area where the pixels of the multivalued image before image processing exist; a second intersection calculating device for calculating a second intersection at which outer circumferential lines of the area including pixels that exist inside the shape of the imaging object are intersected with each other out of the areas divided by the predetermined straight line, the shape being specified by the shape information the input of which has been accepted by the shape information input accepting device; and a polygonal area calculating device for calculating a polygonal area formed by connecting the first intersections calculated by the first intersection calculating device and the second intersections calculated by the second intersection calculating device, and the polygonal area calculated by the polygonal area calculating device is set as the transformation target area.

Moreover, according to another embodiment of the present invention, there is provided an image processing method capable of executing image processing on a multivalued image obtained by picking up an image of an imaging object with an imaging device, the method including the steps of calculating a predetermined projective transformation parameter for projectively transforming a multivalued image before image processing to correct perspective distortion; calculating a projected area, obtained by projectively transforming an area where pixels of the multivalued image before image processing exist to an output area where pixels of a multivalued image after image processing exist, based upon the calculated projective transformation parameter; specifying as an effective area an area in which the calculated projected area is overlapped with the output area where the pixels of the multivalued image after image processing exist; and performing coordinate transformation based upon the specified effective area and the calculated projective transformation parameter, to generate the multivalued image after image processing from the multivalued image before image processing.

Further, according to another embodiment of the present invention, the image processing method includes a step of accepting an input of shape information that specifies shapes of the imaging object before image processing and after image processing on the multivalued image, and calculates the projective transformation parameter based upon the shape information the input of which has been accepted.

Further, according to another embodiment of the present invention, the image processing method accepts the input of the shape information that specifies shapes of the imaging object before image processing and after image processing on the displayed multivalued image before image processing.

Further, according to another embodiment of the present invention, the image processing method switches and displays the multivalued image before image processing, the multivalued image after image processing, and the shape information the input of which has been accepted by the shape information input accepting device.

Further, according to another embodiment of the present invention, the image processing method includes a step of setting as a transformation target area a predetermined area including specific pixels in the area where the pixels of the multivalued image before image processing exist, and calculates the projected area, obtained by projectively transforming the set transformation target area, based upon the calculated projective transformation parameter

Further, according to another embodiment of the present invention, the image processing method sets the predetermined area including specific pixels as the transformation target area out of areas divided by a predetermined straight line defined based upon the projective transformation parameter.

Further, according to another embodiment of the present invention, the image processing method sets, as the transformation target area, a predetermined area including pixels that exist inside the shape of the imaging object, the shape being specified by the shape information the input of which has been accepted.

Further, according to another embodiment of the present invention, the image processing method includes the steps of calculating a first intersection at which a predetermined straight line defined based upon the projective transformation parameter is intersected with an outer circumferential line of the area where the pixels of the multivalued image before image processing exist; calculating a second intersection at which outer circumferential lines of the area including pixels that exist inside the shape of the imaging object are intersected with each other out of the areas divided by the predetermined straight line, the shape being specified by the shape information the input of which has been accepted; calculating a polygonal area formed by connecting the calculated first intersections and the calculated second intersections; and setting the calculated polygonal area as the transformation target area.

Yet, according to another embodiment of the present invention, there is provided a computer program capable of causing an image processing apparatus to execute image processing on a multivalued image obtained by picking up an image of an imaging object with an imaging device, wherein the image processing apparatus is made to function as: a projective transformation parameter calculating device for calculating a predetermined projective transformation parameter for projectively transforming a multivalued image before image processing to correct perspective distortion; a projected area calculating device for calculating a projected area, obtained by projectively transforming an area where pixels of the multivalued image before image processing exist to an output area where pixels of a multivalued image after image processing exist, based upon the projective transformation parameter calculated by the projective transformation parameter calculating device; an effective area specifying device for specifying as an effective area an area in which the projected area calculated by the projected area calculating device is overlapped with the output area where the pixels of the multivalued image after image processing exist; and an image transforming device for performing coordinate transformation based upon the effective area specified by the effective area specifying device and the projective transformation parameter calculated by the projective transformation parameter calculating device, to generate the multivalued image after image processing from the multivalued image before image processing.

Further, according to another embodiment of the present invention, in the computer program, the image processing apparatus is made to function as a shape information input accepting device for accepting an input of shape information that specifies shapes of the imaging object before image processing and after image processing on the multivalued image, and the projective transformation parameter calculating device is made to function as a device for calculating the projective transformation parameter based upon the shape information the input of which has been accepted by the shape information input accepting device.

Further, according to another embodiment of the present invention, in the computer program, the shape information input accepting device is made to function as a device for accepting the input of the shape information that specifies shapes of the imaging object before image processing and after image processing on the displayed multivalued image before image processing.

Further, according to another embodiment of the present invention, in the computer program, the image processing apparatus is made to function as a display switching device for switching and displaying the multivalued image before image processing, the multivalued image after image processing, and the shape information the input of which has been accepted by the shape information input accepting device.

Further, according to another embodiment of the present invention, in the computer program, the image processing apparatus is made to function as a transformation target area setting device for setting as a transformation target area a predetermined area including specific pixels in the area where the pixels of the multivalued image before image processing exist, and the projected area calculating device is made to function as a device for calculating the projected area, obtained by projectively transforming the transformation target area set by the transformation target area setting device, based upon the projective transformation parameter calculated by the projective transformation parameter calculating device.

Further, according to another embodiment of the present invention, in the computer program, the transformation target area setting device is made to function as a device for setting the predetermined area including specific pixels as the transformation target area out of areas divided by a predetermined straight line defined based upon the projective transformation parameter.

Further, according to another embodiment of the present invention, in the computer program, the transformation target area setting device is made to function as a device for setting as the transformation target area a predetermined area including pixels that exist inside the shape of the imaging object, the shape being specified by the shape information the input of which has been accepted by the shape information input accepting device.

Further, according to another embodiment of the present invention, in the computer program, the transformation target area setting device is made to function as: a first intersection calculating device for calculating a first intersection at which a predetermined straight line defined based upon the projective transformation parameter is intersected with an outer circumferential line of the area where the pixels of the multivalued image before image processing exist; a second intersection calculating device for calculating a second intersection at which outer circumferential lines of the area including pixels that exist inside the shape of the imaging object are intersected with each other out of the areas divided by the predetermined straight line, the shape being specified by the shape information the input of which has been accepted by the shape information input accepting device; a polygonal area calculating device for calculating a polygonal area formed by connecting the first intersections calculated by the first intersection calculating device and the second intersections calculated by the second intersection calculating device; and a device for setting the polygonal area, calculated by the polygonal area calculating device, as the transformation target area.

In the embodiment of the present invention, based upon a calculated projective transformation parameter, a projected area is calculated which is obtained by projectively transforming an area where pixels of the multivalued image before image processing exist to an output area where pixels of a multivalued image after image processing exist, an area is specified as an effective area in which the calculated projected area is overlapped with the output area where the pixels of the multivalued image after image processing exist, and coordinate transformation is performed based upon the specified effective area and the calculated projective transformation parameter, to generate the multivalued image after image processing from the multivalued image before image processing. Thereby, it is not necessary to perform projective transformation on a multivalued image out of the effective area, and processing time can be reduced, so as to complete image processing at high speed.

Further, an input of shape information that specifies shapes of the imaging object before image processing and after image processing on the multivalued image is accepted, and the projective transformation parameter is calculated based upon the shape information the input of which has been accepted. It is thereby possible to projectively transform the multivalued image before image processing, so as to calculate with high accuracy a projective transformation parameter for correcting perspective distortion.

Further, the input of the shape information is accepted, the information specifying shapes of the imaging object before image processing and after image processing on the displayed multivalued image before image processing. It is thereby possible to specify with ease shapes of the imaging object before image processing and after image processing, while visually recognizing the multivalued image before image processing which is projectively transformed.

Further, the multivalued image before image processing, the multivalued image after image processing, and the shape information the input of which has been accepted are switched and displayed. It is thereby possible to visually recognize the shape information of the imaging object before image processing and after image processing.

Further, a predetermined area including specific pixels is set as a transformation target area in the area where the pixels of the multivalued image before image processing exist, and based upon the calculated projective transformation parameter, the projected area is calculated which is obtained by projectively transforming the multivalued image before image processing corresponding to the set transformation target area. It is thereby possible to suppress appearance of an unnecessary multivalued image (virtual image), whose polarity based upon a predetermined condition for projective transformation is a reverse polarity, in the multivalued image after image processing. Meanwhile, it is not necessary to perform projective transformation on the multivalued image before image processing which corresponds to the unnecessary multivalued image (virtual image), and processing time can be reduced, so as to complete image processing at high speed.

Further, the predetermined area including specific pixels are set as the transformation target area out of areas divided by a predetermined straight line defined based upon the projective transformation parameter. It is thereby possible to suppress appearance of an unnecessary multivalued image (virtual image), whose polarity based upon a predetermined condition for projective transformation is a reverse polarity, in the multivalued image after image processing.

Further, a predetermined area including pixels that exist inside the shape of the imaging object is set as the transformation target area, the shape being specified by the shape information the input of which has been accepted. It is thereby possible to set with ease a transformation target area including the imaging object.

Further, a first intersection is calculated at which a predetermined straight line defined based upon the projective transformation parameter is intersected with an outer circumferential line of the area where the pixels of the multivalued image before image processing exist, and a second intersection is calculated at which outer circumferential lines of the area including pixels that exist inside the shape of the imaging object are intersected with each other out of the areas divided by the predetermined straight line, the shape being specified by the shape information the input of which has been accepted. A polygonal area formed by connecting the calculated first intersections and the calculated second intersections is calculated, and the calculated polygonal area is set as the transformation target area. It is thereby possible to reliably suppress appearance of an unnecessary multivalued image (virtual image) in the multivalued image after image processing.

According to the above configuration, a projected area is calculated, which is obtained by projectively transforming an area where pixels of a multivalued image before image processing exist to an output area where pixels of a multivalued image after image processing exist, an area is specified as a effective area in which the calculated projected area is overlapped with the output area where the pixels of the multivalued image after image processing exist, and coordinate transformation is performed based upon the specified effective area and a projective transformation parameter calculated by a projective transformation parameter calculating device, to generate the multivalued image after image processing from the multivalued image before image processing. Thereby, it is not necessary to perform projective transformation on a multivalued image in an area other than an effective area, and processing time can be reduced, so as to complete image processing at high speed. Further, by setting a predetermined area including specific pixels as the transformation target area, it is possible to suppress appearance of an unnecessary multivalued image (virtual image), whose polarity based upon a predetermined condition for projective transformation is a reverse polarity, in the multivalued image after image processing.

### BRIEF DESCRIPTION OF THE DRAWINGS

FIG. 1 is a block diagram schematically showing a configuration of an image processing apparatus according to a first embodiment of the present invention;

FIG. 2 is a functional block diagram showing a constitutional example of the image processing apparatus according to the first embodiment of the present invention;

FIG. 3 is a flowchart showing processing steps performed by a main control section of an image processing section in the image processing apparatus according to the first embodiment of the present invention;

FIG. 4 is an illustrative view of a multivalued image displayed in an image displaying device;

FIGS. 5A to 5C are illustrative views each showing a diagram and an input method for inputting shape information that specifies shapes of the imaging object before image processing and after image processing;

FIG. 6 is an illustrative view showing the multivalued image before image processing, and a positional relation between an area where pixels of the multivalued image before image processing exist and a projected area;

FIG. 7 is an illustrative view showing a positional relation between the projected area and an output area where pixels of a multivalued image after image processing exist;

FIG. 8 is an illustrative view of the multivalued image before image processing and the multivalued image after image processing;

FIGS. 9A and 9B are illustrative views each showing a multivalued image before image processing where large perspective distortion has occurred, and a multivalued image after image processing generated from the multivalued image before image processing by correcting the perspective distortion;

FIG. 10 is a functional block diagram showing a constitutional example of an image processing apparatus according to a second embodiment of the present invention;

FIG. 11 is a flowchart showing processing steps performed by a main control section of an image processing section in the image processing apparatus according to the second embodiment of the present invention;

FIG. 12 is an illustrative view of a multivalued image set with a transformation target area;

FIG. 13 is a functional block diagram showing a constitutional example of a transformation target area setting device of the image processing apparatus according to the second embodiment of the present invention;

FIG. 14 is a flowchart showing processing steps for setting the transformation target area, performed by the main control section of the image processing section in the image processing apparatus according to the second embodiment of the present invention;

FIG. 15 is an illustrative view of a multivalued image, where a boundary is not intersected with an outer circumferential line of an area where the pixels of the multivalued image before image processing exist;

FIG. 16 is an illustrative view of a multivalued image in which first intersections have been calculated;

FIG. 17 is an illustrative view of a multivalued image in which second intersections have been calculated;

FIG. 18 is an illustrative view of a multivalued image in which a polygonal area, formed by connecting the first intersections and the second intersections, has been calculated;

FIGS. 19A and 19B are illustrative views showing the multivalued image before image processing which has been set with the transformation target area, and a positional relation between an area where pixels of the multivalued image before image processing exist and a projected area;

FIG. 20 is an illustrative view showing a positional relation between the projected area and an output area where pixels of a multivalued image after image processing exist; and

FIG. 21 is an illustrative view of a multivalued image after projective transformation.

### DETAILED DESCRIPTION OF PREFERRED EMBODIMENTS

Image processing apparatuses according to embodiments of the present invention will be described below with reference to the drawings. It is to be noted that elements having the same or like structures or functions are denoted by the same or like reference numerals throughout the drawings to be referenced, and detailed examples thereof will not be given.

### First Embodiment

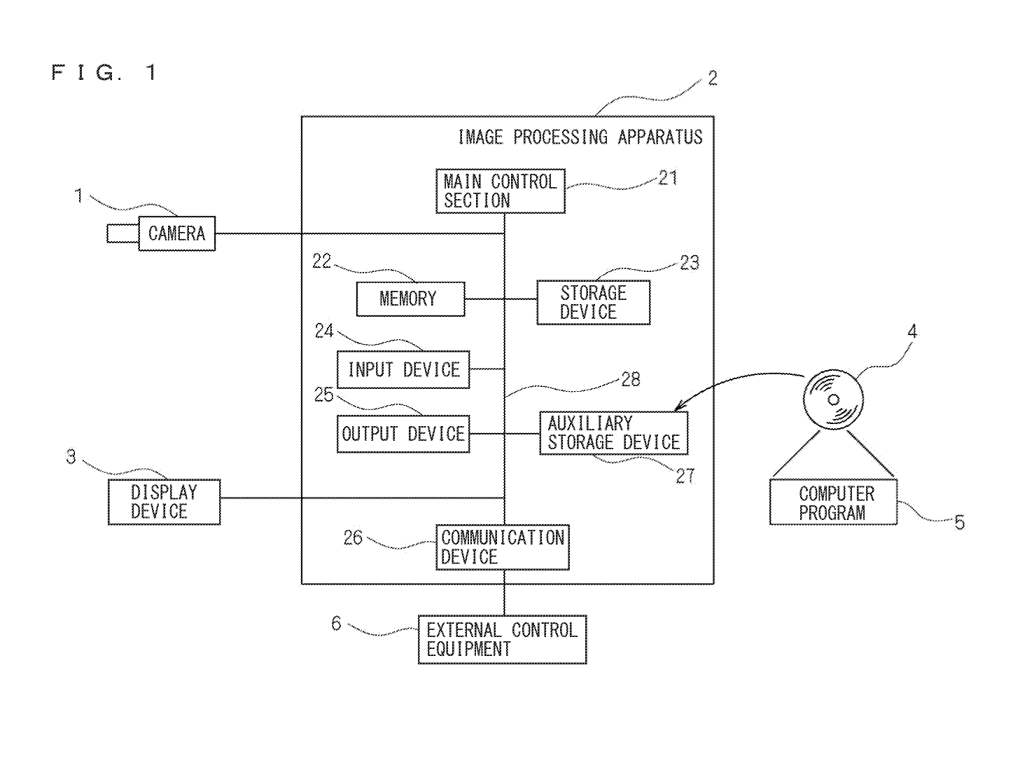

FIG. 1 is a block diagram schematically showing a configuration of an image processing apparatus according to the first embodiment of the present invention. As shown in FIG. 1, an image processing apparatus 2 according to the first embodiment is connected with a camera 1 as an imaging device for picking up a multivalued image, and a display device 3 for displaying a picked-up multivalued image or a projectively transformed multivalued image.

The image processing apparatus 2 is provided with a main control section 21 configured by at least a CPU (central processing unit), an LSI, or the like, a memory 22, a storage device 23, an input device 24, an output device 25, a communication device 26, an auxiliary storage device 27, and an internal bus 28 to which the above hardware components are connected. The main control section 21 is connected to the hardware components of the image processing apparatus 2 as described above via the internal bus 28, and controls operations of the hardware components and executes various software functions according to a computer program 5 stored in the storage device 23. The memory 22 is configured by a volatile memory such as an SRAM or an SDRAM, in which a load module is extracted when executing the computer program 5 and temporary data or the like created when executing the computer program 5 is stored.

The storage device 23 is configured by a built-in fixed storage device (hard disk or flash memory), an ROM, or the like. The computer program 5 stored in the storage device 23 is downloaded from a portable recording medium 4 such as a DVD, a CD-ROM, or a flash memory in which pieces of information such as the program and the data are stored to the auxiliary storage device 27. In execution, the computer program 5 is extracted from the storage device 23 to the memory 22 and executed. It should be appreciated that the computer program 5 can be a computer program downloaded via the communication device 26 from an external computer.

The communication device 26 is connected to the internal bus 28, and is able to transmit and receive data with an external computer and the like by being connected to an external network such as the Internet, a LAN, or a WAN. Specifically, the configuration of the storage device 23 is not limited to a built-in type in the image processing apparatus 2, and can be an external recording medium such as a hard disk provided for an external server computer or the like connected via the communication device 26.

The input device 24 represents a wide concept generally including a variety of devices that acquire inputted information of a touch panel or the like integrated with a liquid crystal panel or the like, in addition to data input media such as a keyboard and a mouse. The output device 25 refers to a printing device such as a laser printer or a dot printer.

The camera (imaging device) 1 is a CCD camera or the like provided with a CCD imaging device. The display device 3 is a display device provided with a CRT, a liquid crystal panel, or the like. The components such as the camera 1 and the display device 3 can be integrated with the image processing apparatus 2 or can be provided separately. External control equipment 6 is a control device connected via the communication device 26, and corresponds to a PLC (programmable logic controller), for example. As used herein, the external control equipment 6 represents a wide concept generally including a variety of devices that execute post-processing in response to a result of image processing by the image processing apparatus 2.

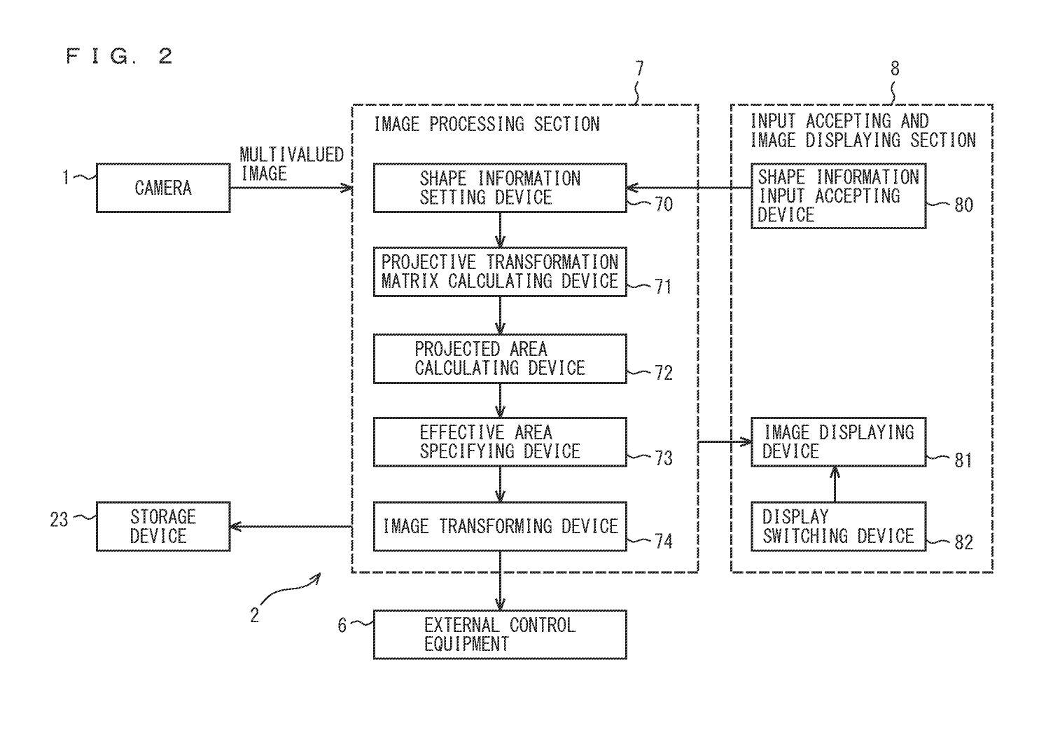

FIG. 2 is a functional block diagram showing a constitutional example of the image processing apparatus 2 according to the first embodiment of the present invention. In FIG. 2, the image processing apparatus 2 according to the first embodiment includes the camera 1, an image processing section 7 for executing processing of the image processing apparatus 2, a storage device 23, and an input accepting/image displaying section 8.

The camera 1 functions, for example, as a digital camera and picks up an image of, for example, an electronic component to be inspected, as an imaging object. The camera 1 acquires a multivalued image, and outputs the image to the image processing section 7.

The image processing section 7 includes a shape information setting device 70, a projective transformation matrix calculating device 71, a projected area calculating device 72, an effective area specifying device 73, and an image transforming device 74. Further, the image processing section 7 is configured to include a main control section 21, a memory 22, a variety of interfaces, and the like, as shown in FIG. 1. The image processing section 7 controls processing operations of the shape information setting device 70, the projective transformation matrix calculating device 71, the projected area calculating device 72, the effective area specifying device 73, and the image transforming device 74.

The storage device 23 functions as an image memory, and stores as needed an original multivalued image picked up by the camera 1, and a multivalued image after a variety of processing having been performed in the image processing section 7.

The input accepting/image displaying section 8 includes a display device 3 such as a monitor for a computer, and an input device 24 such as a mouse and keyboard. The input accepting section is, for example, provided on a display screen of the display device 3 as a dialog box, and includes a shape information input accepting device 80. An image displaying device 81 is provided adjacently to the input accepting section, and displays the multivalued image before image processing, the multivalued image after image processing, and shape information, the input of which has been accepted by the shape information input accepting device 80. A display switching device 82 can switch the multivalued image before image processing, the multivalued image after image processing, and the shape information the input of which has been accepted by the shape information input accepting device 80, based upon a switching instruction accepted in the input device 24, and display a switched screen in the image displaying device 81.

Next, each of configurations of the image processing section 7 will be described.

The shape information setting device 70 sets shape information as information to be used in the projective transformation matrix calculating device 71, the shape information specifying shapes of the imaging object before image processing and after image processing, an input of which has been made by a user and accepted by the shape information input accepting device 80 of the input accepting/image displaying section 8. The shape information that specifies the shapes of the imaging object can be coordinate values at four corners of an upper surface of an electronic component in the shape of a substantially rectangular parallelepiped in the case of using the electronic component as the imaging object.

It is to be noted that the shape information that specifies shapes of the imaging object before image processing and after image processing is information for calculating a projective transformation matrix as a projective transformation parameter of the entire multivalued image by making four points specified in the multivalued image before image processing correspond to four points specified in the multivalued image after image processing. The coordinate values at the four corners of imaging object are not necessarily specified. By using shape information that specifies a different shape that exists on the same imaging plane as the imaging object, the entire multivalued image including the imaging object can be projectively transformed. Further, in the image processing apparatus 2, accepting an input of shape information that specifies shapes of the imaging object before image processing and after image processing and once calculating a projective transformation parameter based upon the shape information can eliminate the need for new calculation of a projective transformation parameter at the time of image processing unless readjustment is needed. With no need for calculation of a projective transformation parameter at the time of image processing, the image processing apparatus 2 can perform image processing on the multivalued image picked up by the imaging device in real time by use of the once calculated projective transformation parameter.

When the input of shape information is accepted by the shape information input accepting device 80, based upon the shape information the input of which has been accepted, the projective transformation matrix calculating device (projective transformation parameter calculating device) 71 calculates a projective transformation matrix as a predetermined projective transformation parameter for projectively transforming the multivalued image before image processing to correct perspective distortion.

It is to be noted that the projective transformation matrix calculated by the projective transformation matrix calculating device 71 represents a projective transformation matrix that transforms a coordinate of the multivalued image after image processing to a coordinate of the multivalued image before image processing. Image processing associated with coordinate transformation normally requires previous calculation of a transformation parameter for transforming a coordinate of the multivalued image after image processing (coordinate of a transformation destination) to a coordinate of the multivalued image before image processing (coordinate of a transformation source). By previously calculating this transformation parameter, it is possible to thoroughly specify a coordinate of the multivalued image before image processing which correspond to a coordinate of each pixel in the multivalued image after image processing, so as to perform image processing with high accuracy without occurrence of problems such as pixels (defective pixels) with coordinates not transformed in the multivalued image after image processing.

The projected area calculating device 72 calculates a projected area, obtained by projectively transforming an area where pixels of the multivalued image before image processing exist to an output area where pixels of the multivalued image after image processing exist, based upon inverse transformation of the projective transformation matrix calculated by the projective transformation parameter calculating device 71. The effective area specifying device 73 specifies, as an effective area, an area in which the projected area calculated by the projected area calculating device 72 is overlapped with the output area where the pixels of the multivalued image after image processing exist. It is to be noted that the area where the pixels of the multivalued image before image processing exist may be an area including all the pixels of the multivalued image picked up by the camera 1, or the area can be restricted to a predetermined area including pixels that exist inside the shape of the imaging object specified by the shape information. Herein, the multivalued image before image processing is an original multivalued image picked up by the camera 1, and the multivalued image after image processing is a multivalued image outputted after projective transformation by the image processing section 7.

The image transforming device 74 performs coordinate transformation from coordinates of the multivalued image after image processing (coordinates of the transformation destination) to coordinates of the multivalued image before image processing (coordinates of the transformation source) based upon the projective transformation matrix exclusively, in the effective area specified by the effective area specifying device 73, thereby to generate the multivalued image after image processing with corrected perspective distortion. The multivalued image after projectively transformed by the image transforming device 74 may be outputted to external control equipment 6, while being displayed in the image displaying device 81.

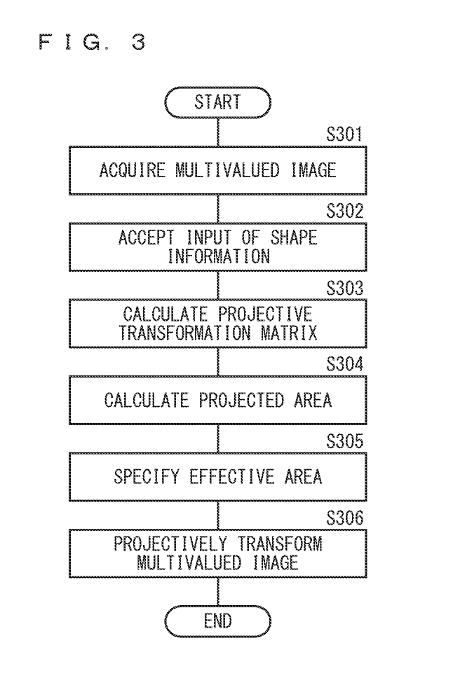

FIG. 3 is a flowchart showing processing steps performed by the main control section 21 of the image processing section 7 in the image processing apparatus 2 according to the first embodiment of the present invention. Each processing step for an image processing method according to the first embodiment of the present invention is executed in line with a computer program 5 according to the present invention which is stored inside the image processing section 7.

In FIG. 3, the main control section 21 of the image processing section 7 acquires a multivalued image of the imaging object picked up by the camera 1 (step S301). The main control section 21 accepts the input of shape information, made by the user, the information specifying shapes of the imaging object before image processing and after image processing (step S302).

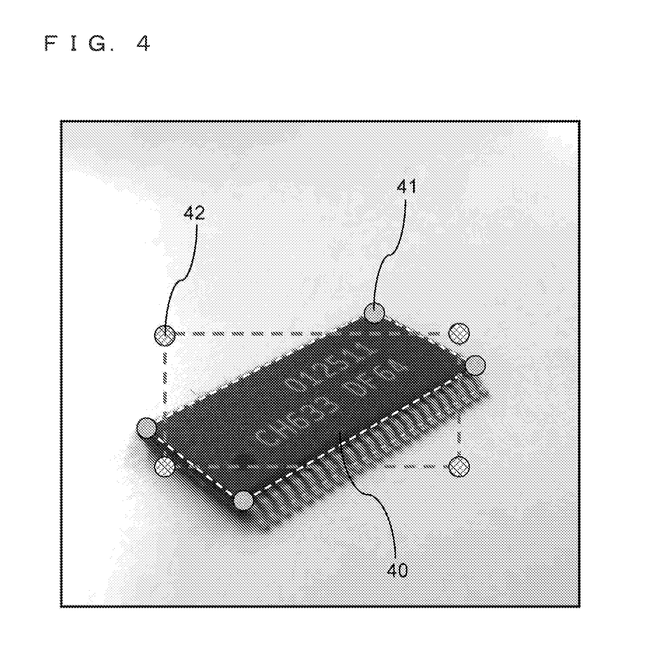

FIG. 4 is an illustrative view of a multivalued image displayed in the image displaying device 81. The multivalued image shown in FIG. 4 is a multivalued image including an electronic component 40 as the imaging object, and shape information 41, 42 that specify shapes of the imaging object before image processing and after image processing are shown. It should be noted that the shape information 41, 42 are information for specifying the shapes of the electronic component 40 and may be, for example, four coordinates on the display screen which correspond to the four corners of the upper surface of the electronic component 40 in the shape of a substantially rectangular parallelepiped. Further, in the case of displaying the shape information 41, 42 in the image displaying device 81, other than the four coordinates on the display screen which correspond to the four corners of the upper surface of the electronic component 40, a broken line connecting the four coordinates can also be displayed, to enhance the visibility.

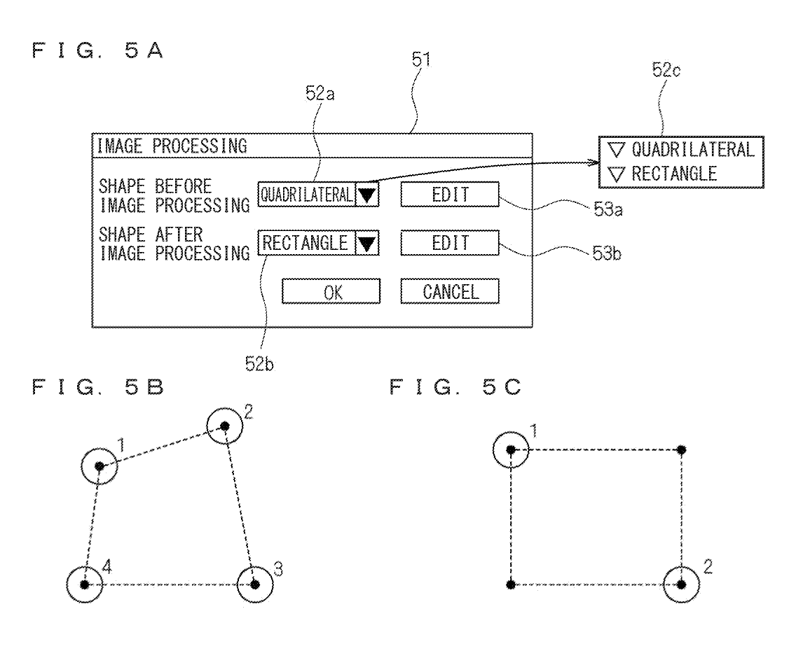

FIGS. 5A to 5C are illustrative views of a diagram and an input method which are displayed for inputting shape information that specifies shapes of the imaging object before image processing and after image processing. At the time of the user inputting shape information that specifies shapes of the imaging object before image processing and after image processing, a diagram 51 as shown in FIG. 5A is displayed in the image displaying device 81. In the diagram 51, there are separately prepared: a pull-down box 52a for inputting shape information that specifies a shape of the imaging object before image processing; an edit button 53a; a pull-down box 52b for inputting shape information that specifies a shape of the imaging object after image processing; and an edit button 53b.

For example, the user selects the pull-down box 52a with the input device 24 such as the mouse, to get the pull-down list 52c open, and specify “RECTANGLE” from the pull-down list 52c. The user specifies “RECTANGLE”, selects the edit button 53a with the input device 24 such as the mouse, and specifies the four corners of the electronic component 40 displayed in the image displaying device 81 with the input device 24 such as the mouse. In addition, when specifying “RECTANGLE” from the pull-down list 52c, the user specifies four points as shown in FIG. 5B with the input device 24 such as the mouse, and inputs four coordinates that specify a shape of the electronic component 40 as shape information. Further, when specifying “RECTANGLE” from the pull-down list 52c, the user can specify just two points diagonal to each other as shown in FIG. 5C with the input device 24 such as the mouse, thereby to input four coordinates as shape information, which specify a shape of the electronic component 40.

Returning to FIG. 3, when the main control section 21 of the image processing section 7 accepts the input of the shape information, made by the user, the information specifying shapes of the imaging object before image processing and after image processing (step S302), based upon the shape information the input of which has been accepted, the main control section 21 calculates a projective transformation matrix for projectively transforming the multivalued image before image processing, to correct perspective distortion (step S303). A coordinate (x′, y′) of the multivalued image before image processing and a coordinate (x, y) of the multivalued image after image processing can be represented as Equation 1 and Equation 2 by means of a projective transformation matrix H having matrix elements a to h. It should be noted that the projective transformation matrix H represents a projective transformation matrix for performing coordinate transformation from the coordinate of the multivalued image after image processing to the coordinate of the multivalued image before image processing, which is required for projectively transforming the multivalued image before image processing to correct perspective distortion.

$$\begin{matrix}[ Mathematical Formula 1 ] & \\ ( \begin{matrix}{x}^{′} \\ {y}^{′} \\ 1\end{matrix} ) ≅ ( \begin{matrix}a & b & c \\ d & e & f \\ g & h & 1\end{matrix} ) \times ( \begin{matrix}x \\ y \\ 1\end{matrix} ) & ( Equation 1 ) \\ \begin{matrix}{x}^{′} = ( ax + by + c ) / ( gx + hy + 1 ) \\ {y}^{′} = ( dx + ey + f ) / ( gx + hy + 1 )\end{matrix} \} & ( Equation 2 )\end{matrix}$$

It is to be noted that, although a matrix having matrix elements a to i may be used for the projective transformation matrix H as in Equation 3, the matrix shown in Equation 1 is used in the first embodiment, where values of the matrix elements other than the matrix element i are divided by the matrix elements i, to reduce the matrix elements by one.

$$\begin{matrix}[ Mathematical Formula 2 ] & \\ ( \begin{matrix}a & b & c \\ d & e & f \\ g & h & i\end{matrix} ) & ( Equation 3 )\end{matrix}$$

In step S303, for calculation of the projective transformation matrix H, four coordinates (x₁′, y₁′) to (x₄′, y₄′) as shape information that specifies a shape of the imaging object before image processing and four coordinates (x₁, y₁) to (x₄, y₄) as shape information that specifies a shape of the imaging object after image processing, the input of which has been accepted in step S302, are substituted into Equation 1 or Equation 2, and eight simultaneous equations shown in FIG. 4 are solved, to obtain the matrix elements a to h.

$$\begin{matrix}[ Mathematical Formula 3 ] & \\ ( \begin{matrix}{x}_{1} & {y}_{1} & 1 & 0 & 0 & 0 & - {x}_{1} * {x}_{1}^{′} & - {y}_{1} * {x}_{1}^{′} \\ 0 & 0 & 0 & {x}_{1} & {y}_{1} & 1 & - {x}_{1} * {y}_{1}^{′} & - {y}_{1} * {y}_{1}^{′} \\ {x}_{2} & {y}_{2} & 1 & 0 & 0 & 0 & - {x}_{2} * {x}_{2}^{′} & - {y}_{2} * {x}_{2}^{′} \\ 0 & 0 & 0 & {x}_{2} & {y}_{2} & 1 & - {x}_{2} * {y}_{2}^{′} & - {y}_{2} * {y}_{2}^{′} \\ {x}_{3} & {y}_{3} & 1 & 0 & 0 & 0 & - {x}_{3} * {x}_{3}^{′} & - {y}_{3} * {x}_{3}^{′} \\ 0 & 0 & 0 & {x}_{3} & {y}_{3} & 1 & - {x}_{3} * {y}_{3}^{′} & - {y}_{3} * {y}_{3}^{′} \\ {x}_{4} & {y}_{4} & 1 & 0 & 0 & 0 & - {x}_{4} * {x}_{4}^{′} & - {y}_{4} * {x}_{4}^{′} \\ 0 & 0 & 0 & {x}_{4} & {y}_{4} & 1 & - {x}_{4} * {y}_{4}^{′} & - {y}_{4} * {y}_{4}^{′}\end{matrix} ) \times ( \begin{matrix}a \\ b \\ c \\ d \\ e \\ f \\ g \\ h\end{matrix} ) = ( \begin{matrix}{x}_{1}^{′} \\ {y}_{1}^{′} \\ {x}_{2}^{′} \\ {y}_{2}^{′} \\ {x}_{3}^{′} \\ {y}_{3}^{′} \\ {x}_{4}^{′} \\ {y}_{4}^{′}\end{matrix} ) & ( Equation 4 )\end{matrix}$$

The projective transformation matrix H shown in Equation 1 is a matrix for projectively transforming the coordinate (x, y) of the multivalued image after image processing to the coordinate (x′, y′) of the multivalued image before image processing. In order to projectively transform the coordinate (x′, y′) of the multivalued image before image processing to the coordinate (x, y) of the multivalued image after image processing, it is required to obtain an inverse matrix (Equation 5) of the projection transformation matrix H, as an inverse matrix of the projective transformation matrix H shown in Equation 1. It should be noted that in order to obtain the projective transformation matrix for transforming the coordinate (x′, y′) of the multivalued image before image processing to the coordinate (x, y) of the multivalued image after image processing, it is not necessarily required to calculate the matrix by obtaining an inverse matrix of the projective transformation matrix H, but the matrix may be directly calculated from a corresponding relation between the coordinate (x, y) of the multivalued image after image processing and the coordinate (x′, y′) of the multivalued image before image processing. Also in the inverse matrix of the projective transformation matrix H shown in Equation 5, values of the matrix elements other than the matrix element i′ are divided by the matrix elements i′, to reduce the matrix elements by one.

$$\begin{matrix}[ Mathematical Formula 4 ] & \\ ( \begin{matrix}{a}^{′} & {b}^{′} & {c}^{′} \\ {d}^{′} & {e}^{′} & {f}^{′} \\ {g}^{′} & {h}^{′} & 1\end{matrix} ) & ( Equation 5 )\end{matrix}$$

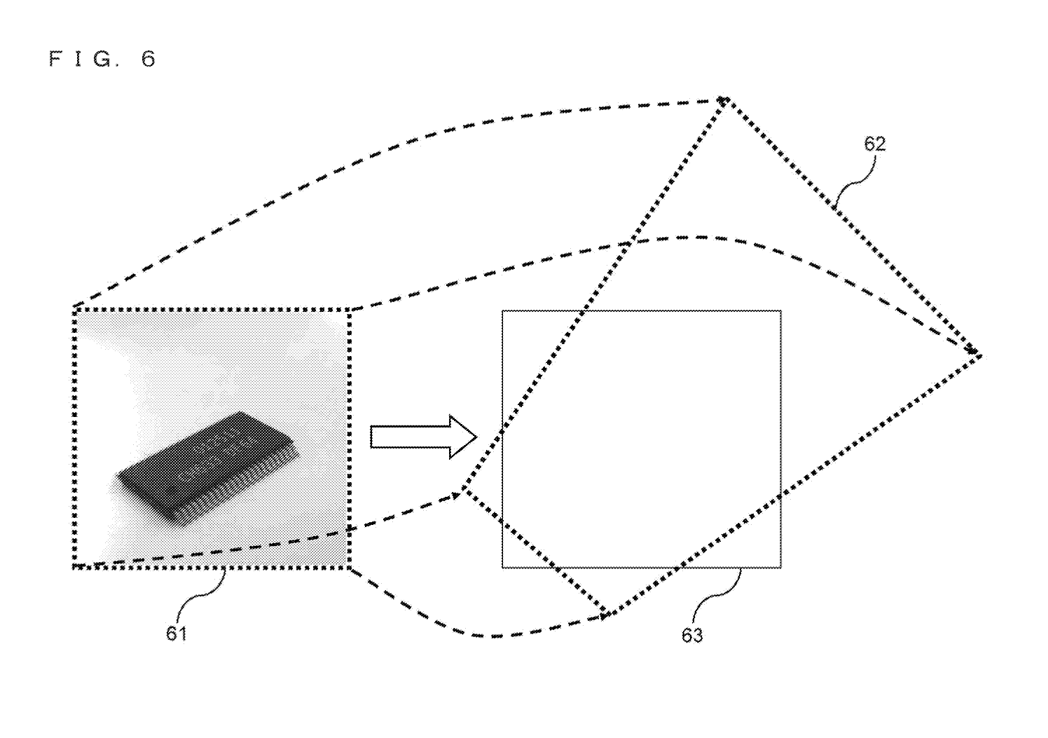

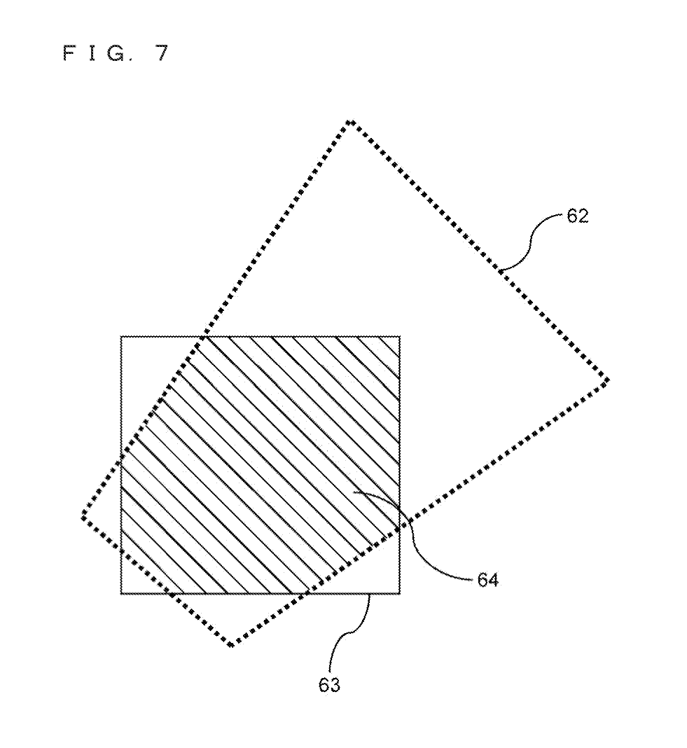

Returning to FIG. 3, the main control section 21 calculates a projected area, obtained by projectively transforming the area where the pixels of the multivalued image before image processing exist to the output area where the pixels of the multivalued image after image processing exist (step S304), based upon inverse transformation of the projective transformation matrix H calculated in step S303 (step S304). Next, the main control section 21 specifies, as an effective area, an area in which the projected area calculated in step S304 is overlapped with the output area where the pixels of the multivalued image after image processing exist (step S305). FIG. 6 is an illustrative view showing the multivalued image before image processing, and a positional relation between the area where the pixels of the multivalued image before image processing exist and the projected area. As shown in FIG. 6, a projected area 62 obtained by projectively transforming an area 61 which is displayed in the image displaying device 81 and where the pixels of the multivalued image before image processing exist to an output area 63 where the pixels of the multivalued image after image processing exist, based upon inverse transformation of the projective transformation matrix H. Specifically, it is possible to obtain coordinates at the four corner of the projected area 62, which are obtained by projectively transforming coordinates at the four corners of the area 61 where the pixels of the multivalued image before image processing exist to the output area 63 where the pixels of the multivalued image after image processing exist, based upon inverse transformation of the projective transformation matrix H.

Moreover, FIG. 7 is an illustrative view showing a positional relation between the projected area 62 and the output area 63 where the pixels of the multivalued image after image processing exist. As shown in FIG. 7, the projected area 62 is overlapped with the output area 63 where the pixels of the multivalued image after image processing exist, and the overlapping area is specified as the effective area 64. The output area 63 where the pixels of the multivalued image after image processing exist is a display area of the multivalued image which is outputted after projective transformation performed in the image processing section 7. In the first embodiment, the output area 63 is an area as wide as the area 61 where the pixels of the multivalued image before image processing exist.

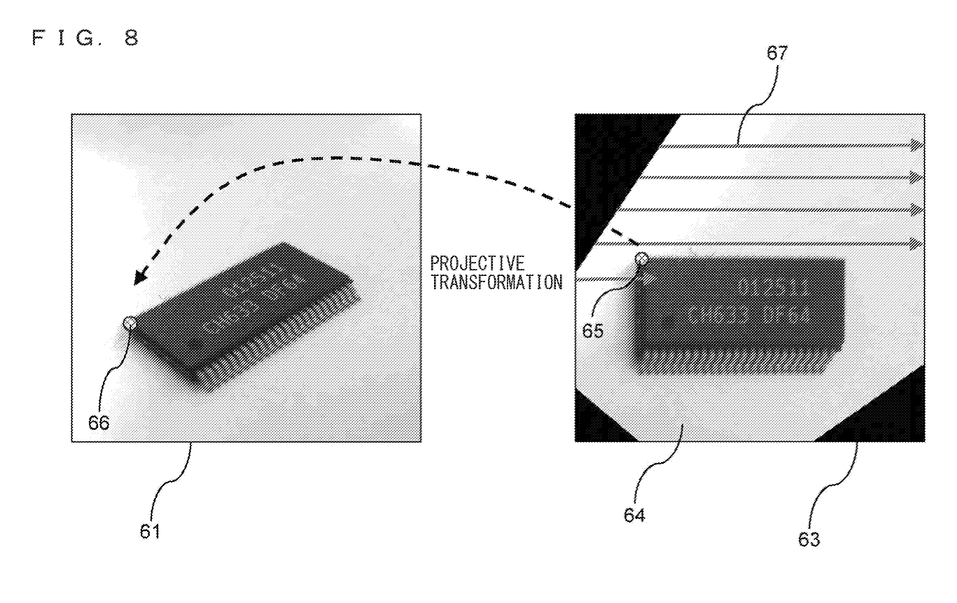

Returning to FIG. 3, the main control section 21 performs coordinate transformation from coordinates of the multivalued image after image processing (coordinates of the transformation destination) to coordinates of the multivalued image before image processing (coordinates of the transformation source) based upon the projective transformation matrix, exclusively in the effective area 64 specified in step S305 (step S306), thereby to generate a multivalued image after image processing with corrected perspective distortion. FIG. 8 is an illustrative view of the multivalued image before image processing and the multivalued image after image processing. As shown in FIG. 8, when a coordinate of the pixels 65 existing in the effective area 64 is projectively transformed based upon the projective transformation matrix H, a coordinate 66 of the area 61 where the pixels of the multivalued image before image processing exist is obtained, whereby a pixel 65 existing in the effective area 64 corresponds to the multivalued image before image processing at the coordinate 66 of the area 61 where the pixels of the multivalued image before image processing exist. Therefore, sequentially in an order indicated with arrows 67, the main control section 21 obtains coordinates inside the area 61 where the pixels of the multivalued image before image processing exist which are obtained by projectively transforming coordinates of pixels existing in the effective area 64 based upon the projective transformation matrix H, to generate a multivalued image after image processing with corrected perspective distortion.

It is to be noted that the nearest pixel of the coordinate 66 obtained by projectively transforming the pixel 65 of the effective area 64 based upon the projective transformation matrix H can be taken, as it is, as the pixel 65 of the effective area 64. In order to generate a multivalued image after image processing with higher accuracy, a pixel in the vicinity of the obtained coordinate 66 is interpolated and taken as the pixel 65 of the effective area 64. As for an interpolation method, for example, bilinear interpolation may be employed where the four nearest pixels are linearly interpolated, but the present invention is not restricted to this interpolation method.

Herein, the effective area 64 shows an area where the multivalued image before image processing can be displayed in the output area 63 where the pixels of the multivalued image after image processing exist in the case of generating the multivalued image after image processing with corrected perspective distortion from the multivalued image before image processing based upon the projective transformation matrix H. Therefore, an area other than the effective area 64 out of the entire output area 63 is an area that does not exist in the multivalued image before image processing, and is not required to be projectively transformed based upon the projective transformation matrix H. It is to be noted that in the first embodiment, the projective transformation matrix H, used in image processing to generate the multivalued image after image processing with corrected perspective distortion from the multivalued image before image processing, is not necessarily calculated based upon shape information that specifies shapes of the imaging object before image processing and after image processing. For example, calibration processing may be performed using a multivalued image obtained by picking up a calibration pattern printed with a pattern of dots at fixed intervals, or the like, thereby to calculate a projective transformation matrix.

Although the description was given in the first embodiment to the image processing steps for generating the multivalued image after image processing with corrected perspective distortion after previous obtainment of the effective area, image processing may be performed while specifying the effective area in the process of generating the multivalued image after image processing. In other words, the multivalued image may be specified by determining whether the pixels of the multivalued image after image processing exist inside or outside the projected area 62 in the process of generating the multivalued image after image processing. When the pixels of the multivalued image after image processing exist inside the projected area 62, the nearest pixel of the coordinate 66 obtained by performing projective transformation based upon the projective transformation matrix H can be taken, as it is, as the pixel 65 of the effective area 64. When the pixels exist outside the projected area 62, image processing, such as processing of setting pixel values to 0 (zero) while not performing projective transformation, may be performed.

As described above, in the image processing apparatus 2 according to the first embodiment of the present invention, based upon inverse transformation of the projective transformation matrix H, the projected area calculating device 72 calculates the projected area 62, obtained by projectively transforming the area 61 where the pixels of the multivalued image before image processing exist to the output area 63 where the pixels of the multivalued image after image processing exist. The effective area specifying device 73 specifies, as the effective area 64, an area in which the projected area 62 is overlapped with the output area 63 where the pixels of the multivalued image after image processing exist. Based upon the projective transformation matrix, the image transforming device 74 performs coordinate transformation from coordinates of the multivalued image after image processing (coordinates of the transformation destination) to coordinates of the multivalued image before image processing (coordinates of the transformation source) exclusively in the effective area 64, to generate a multivalued image after image processing with corrected perspective distortion. Thereby, it is not necessary to perform projective transformation on a multivalued image out of the effective area 64, and processing time can be reduced, so as to complete image processing at high speed.

### Second Embodiment

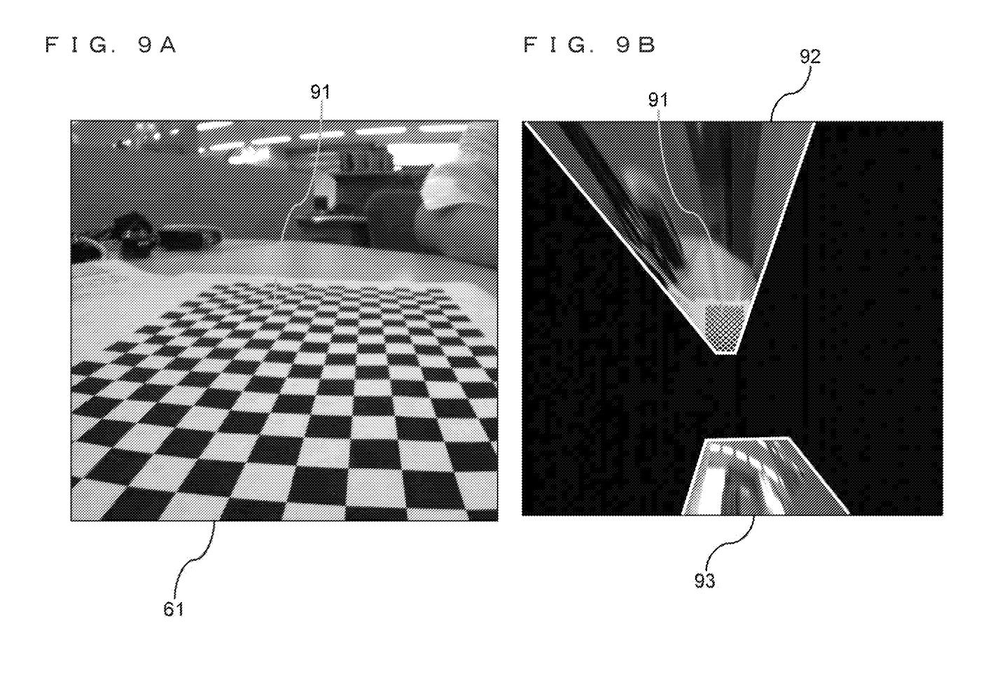

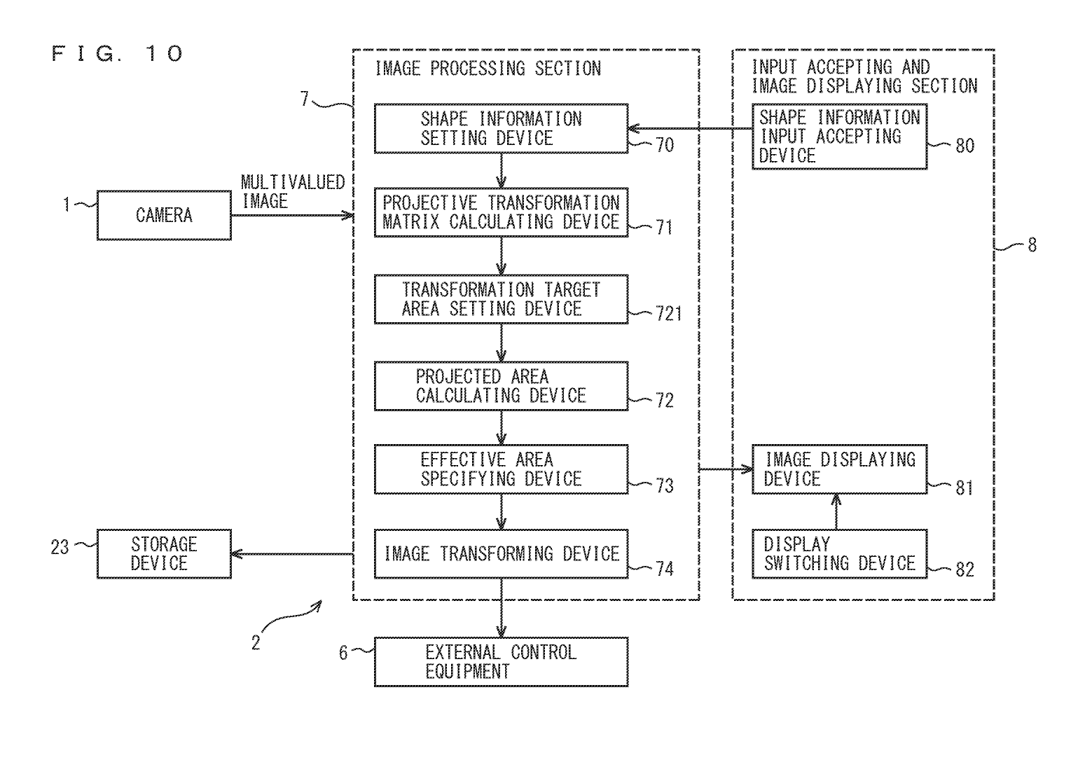

FIGS. 9A and 9B are illustrative views of a multivalued image before image processing where large perspective distortion has occurred, and a multivalued image after image processing generated from the multivalued image before image processing by correcting the perspective distortion. FIG. 9A is a multivalued image before image processing where large perspective distortion has occurred and a distant background appears other than an imaging object 91. FIG. 9B is a multivalued image after image processing generated from the multivalued image before image processing shown in FIG. 9A by correcting the perspective distortion. As shown in FIG. 9B, a multivalued image 93 on the lower side of the figure is an unnecessary multivalued image (virtual image) whose polarity based upon a predetermined condition for projective transformation is a reverse polarity. In a second embodiment, there is described a configuration of the image processing apparatus 2 where performing projective transformation on the multivalued image 93 as an unnecessary multivalued image (virtual image) is not necessary. It is to be noted that the same configuration as the image processing apparatus 2 according to the first embodiment is provided with the same reference numeral, and a detailed description thereof is not given.

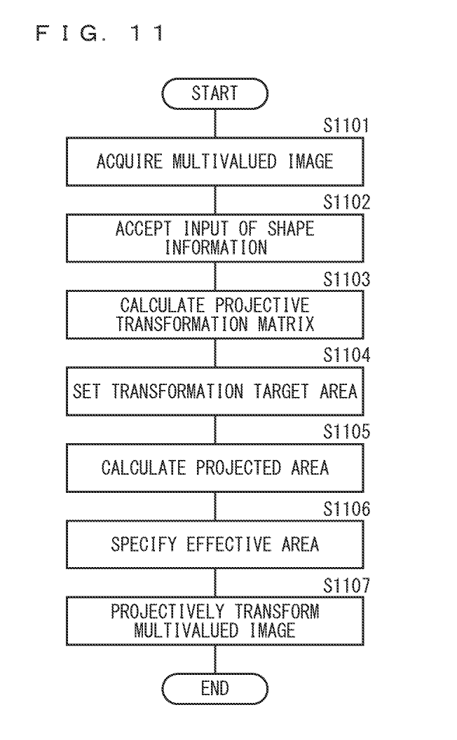

FIG. 10 is a functional block diagram showing a constitutional example of the image processing apparatus 2 according to the second embodiment of the present invention. As shown in FIG. 10, the image processing apparatus 2 according to the second embodiment of the present invention has the same configuration as that of the image processing apparatus 2 according to the first embodiment shown in FIG. 2 except for being provided with a transformation target area setting device 721.

In an area where pixels of the multivalued image before image processing exist, the transformation target area setting device 721 sets, as a transformation target area, a predetermined area including pixels that exist inside the shape of the imaging object specified by shape information, the input of which has been accepted by the shape information input accepting device 80. In the area 61 shown in FIG. 9A where the pixels of the multivalued image exist, a predetermined area including pixels that exist inside the shape of the imaging object 91 is set as the transformation target area. It is to be noted that setting of the transformation target area is described in detail later.

Based upon inverse transformation of the projective transformation matrix H calculated by the projective transformation matrix calculating device 71, in the area 61 where the pixels of the multivalued image before image processing exist, the projected area calculating device 72 calculates a projected area obtained by projectively transforming the transformation target area set by the transformation target area setting device 721 to the output area 63 where pixels of a multivalued image after image processing exist.

Further, the effective area specifying device 73 specifies, as the effective area 64, an area in which the projected area obtained by projectively transforming the transformation target area of the multivalued image before image processing to the output area 63 where the pixels of the multivalued image after image processing exist, is overlapped with the output area 63 where the pixels of the multivalued image after image processing exist.

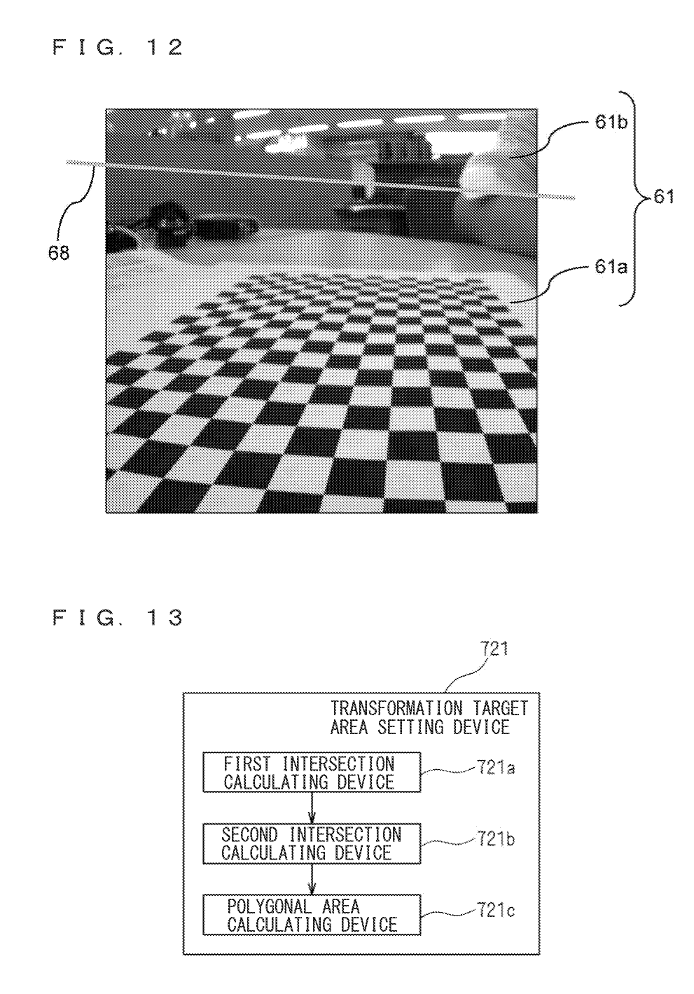

FIG. 11 is a flowchart showing processing steps performed by the main control section 21 of the image processing section 7 in the image processing apparatus 2 according to the second embodiment of the present invention. Each processing step for an image processing method according to the second embodiment of the present invention is executed in line with a computer program 5 according to the present invention which is stored inside the image processing section 7.

As shown in FIG. 11, the flowchart showing the processing steps performed by the main control section 21 of the image processing section 7 in the image processing apparatus 2 according to the second embodiment of the present invention includes the same steps as the flowchart showing the processing steps performed by the main control section 21 of the image processing section 7 in the image processing apparatus 2 according to the first embodiment shown in FIG. 3, except for addition of a step of setting a transformation target area.

In step S1101 which corresponds to step S301, the main control section 21 of the image processing section 7 acquires a multivalued image picked up by the camera 1. In step S1102 which corresponds to step S302, the main control section 21 accepts an input of shape information, made by the user, the information specifying shapes of the imaging object before image processing and after image processing. In step S1103 which corresponds to step S303, the main control section 21 projectively transforms the multivalued image before image processing based upon the shape information the input of which has been accepted, to calculate the projective transformation matrix H for correcting perspective distortion. It should be noted that the projection transformation matrix H represents a projective transformation matrix for performing coordinate transformation from a coordinate of the multivalued image after image processing to a coordinate of the multivalued image before image processing. In step S1104, the main control section 21 of the image processing section 7 sets, as a transformation target area, a predetermined area including pixels that exist inside the shape of the imaging object 91 specified by the shape information, the input of which has been made by the user and accepted.

The processing for obtaining a predetermined area to be set as a transformation target area will be further described. FIG. 12 is an illustrative view of a multivalued image set with a transformation target area. When projective transformation is performed on the area 61 shown in FIG. 12 where the pixels of the multivalued image before image processing exist, the area 61 where the pixels of the multivalued image before image processing is divided into an area 61a including the multivalued image 92 and an area 61b including the unnecessary multivalued image (virtual image) 93, as shown in FIG. 9B. A boundary 68 between the area 61a and the area 61b can be represented by Equation 6, using the matrix elements of the inverse matrix of the projective transformation matrix H shown in Equation 5. It is to be noted that a value obtained by substituting a coordinate (x, y) inside the area 61a into Equation 6 is opposite in sign to a value obtained by substituting a coordinate (x, y) inside the area 61b into Equation 6. Equation 6 is a predetermined condition for projective transformation.

[Mathematical Formula 5]

g′x+h′x+1=0 (Equation 6)

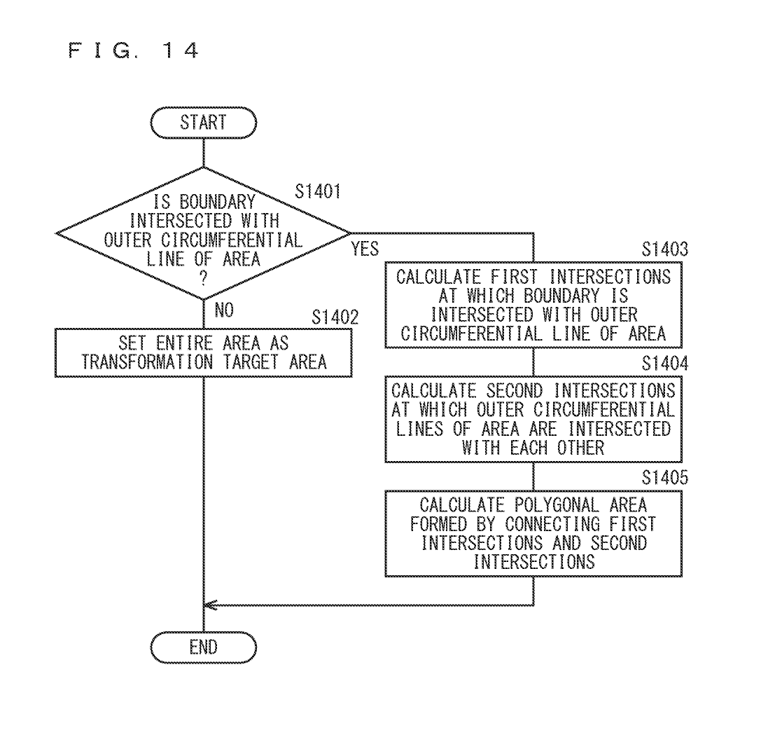

Hereinafter, processing for obtaining a predetermined area to be set as the transformation target area will be described by use of the boundary 68 representable by Equation 6. FIG. 13 is a functional block diagram showing a constitutional example of a transformation target area setting device 721 of the image processing apparatus 2 according to the second embodiment of the present invention. In FIG. 13, the transformation target area setting device 721 of the image processing apparatus 2 according to the second embodiment includes a first intersection calculating device 721a, a second intersection calculating device 721b, and a polygonal area calculating device 721c.

The first intersection calculating device 721a calculates a first intersection at which the boundary 68 that is defined based upon matrix elements (g′, h′, 1) of the inverse matrix of the projective transformation matrix H is intersected with an outer circumferential line of the area 61 where the pixels of the multivalued image before image processing exist.

The second intersection calculating device 721b calculates a second intersection at which outer circumferential lines of an area are intersected with each other, the area including pixels that exist inside the shape of the imaging object specified by the shape information the input of which has been accepted by the shape information input accepting device 80, out of the areas 61 which were divided by the boundary 68 and in which the pixels of the multivalued image before image processing exist.

The polygonal area calculating device 721c calculates a polygonal area formed by connecting the first intersections calculated by the first intersection calculating device 721a and the second intersections calculated by the second intersection calculating device 721b. The polygonal area calculated by the polygonal area calculating device 721c is set as the transformation target area of the transformation target area setting device 721.

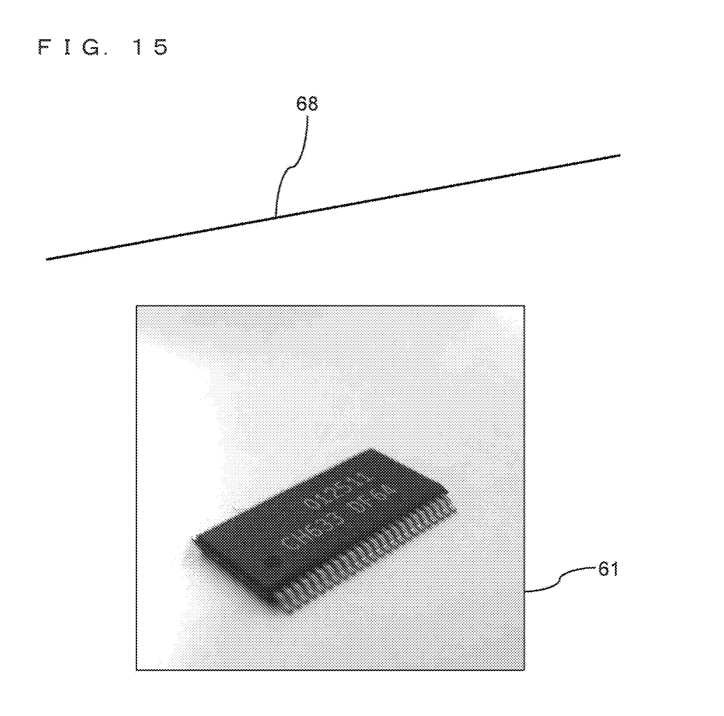

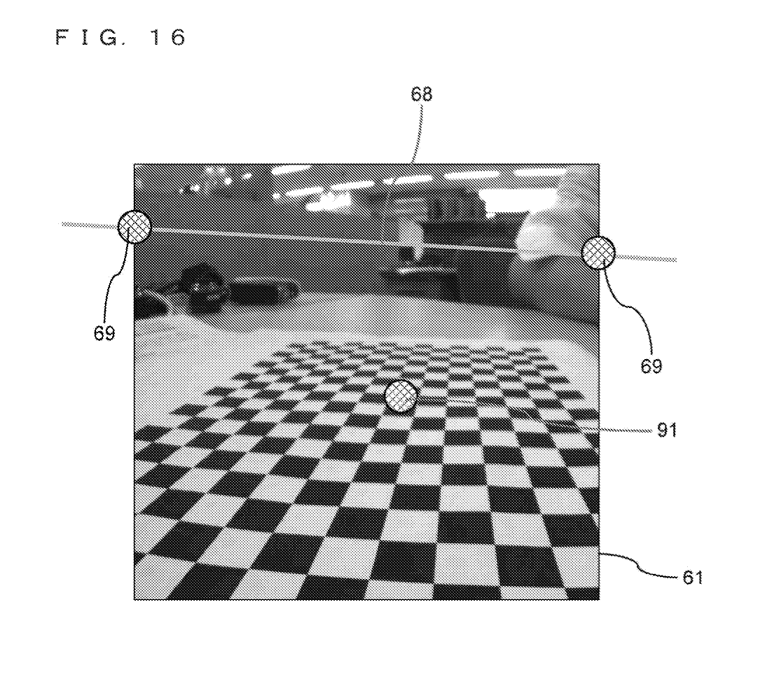

FIG. 14 is a flowchart showing processing steps for setting the transformation target area which is performed by the main control section 21 of the image processing section 7 in the image processing apparatus 2 according to the second embodiment of the present invention. In FIG. 14, the main control section 21 of the image processing section 7 determines whether or not the boundary 68 is intersected with the outer circumferential line of the area 61 where the pixels of the multivalued image before image processing exist (step S1401). When the main control section 21 determines that the boundary 68 is not intersected with the outer circumferential line of the area 61 where the pixels of the multivalued image before image processing exist (step S1401: NO), the main control section 21 sets, as the transformation target area, the entire area 61 where the pixels of the multivalued image before image processing exist (step S1402). FIG. 15 is an illustrative view of a multivalued image, in which the boundary 68 is not intersected with the outer circumferential line of the area 61 where the pixels of the multivalued image before image processing exist. As shown in FIG. 15, when the boundary 68 is located outside the area 61 where the pixels of the multivalued image before image processing exist, the boundary 68 is not intersected with the outer circumferential line of the area 61 where the pixels of the multivalued image before image processing exist, and the main control section 21 sets, as the transformation target area, the entire area 61 where the pixels of the multivalued image before image processing exist.

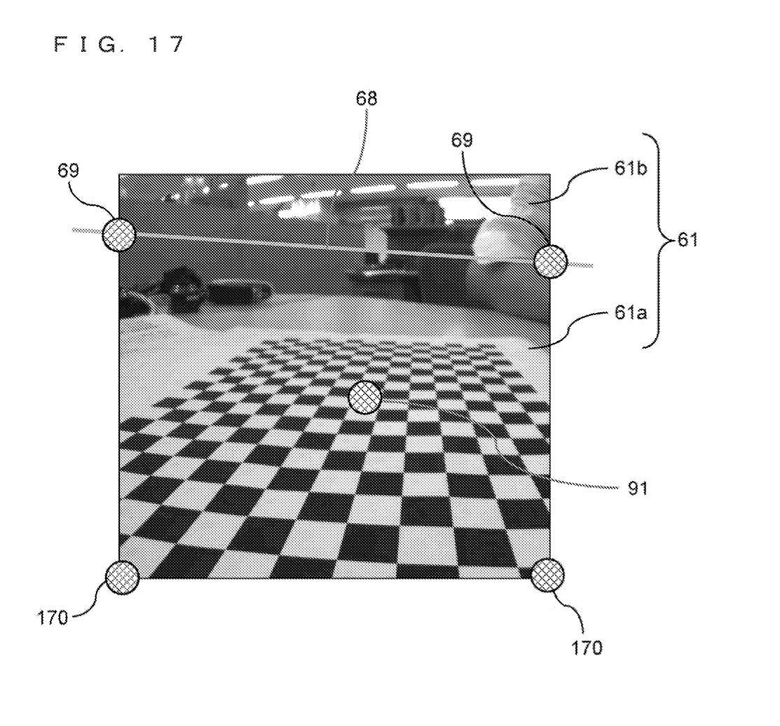

When the main control section 21 determines that the boundary 68 is intersected with the outer circumferential line of the area 61 where the pixels of the multivalued image before image processing exist (step S1401: YES), the main control section 21 calculates first intersections at which the boundary 68 is intersected with the outer circumferential line of the area 61 where the pixels of the multivalued image before image processing exist (step S1403). FIG. 16 is an illustrative view of a multivalued image in which first intersections have been calculated. As shown in FIG. 16, the main control section 21 calculates first intersections 69, 69 at which the boundary 68 is intersected with the outer circumferential line of the area 61 where the pixels of the multivalued image before image processing exist.

Next, the main control section 21 calculates second intersections at which outer circumferential lines of an area are intersected with each other, the area including pixels that exist inside the shape of the imaging object 91 specified by the shape information, the input of which has been accepted in step S1102, out of the areas 61 which were divided by the boundary 68 and in which the pixels of the multivalued image before image processing exist (step S1404). FIG. 17 is an illustrative view of a multivalued image in which second intersections have been calculated. As shown in FIG. 17, the main control section 21 calculates second intersections 170, 170 at which outer circumferential lines of the area 61a are intersected with each other, the area 61a including pixels that exist inside the shape of the imaging object 91, out of the areas 61 which were divided by the boundary 68 and in the which pixels of the multivalued image before image processing exist. It is to be noted that in step S1404, the use of information that specifies an area on the side where the second intersection 170, 170 are calculated is not restricted to the case of using shape information the input of which has been accepted in step S1102. An input of information that specifies an area may be separately accepted, or this information may be used. For example, the area may be specified to an area on the side including a central point of the image, or may be specified to an area on the side having a larger area, with respect to the boundary 68. Further, the outer circumferential line of the area 61 where the pixels of the multivalued image before image processing exist is not necessarily a line indicating a boundary of an image. For example, it may be an outer circumferential line restricted by a specific polygon or the like.

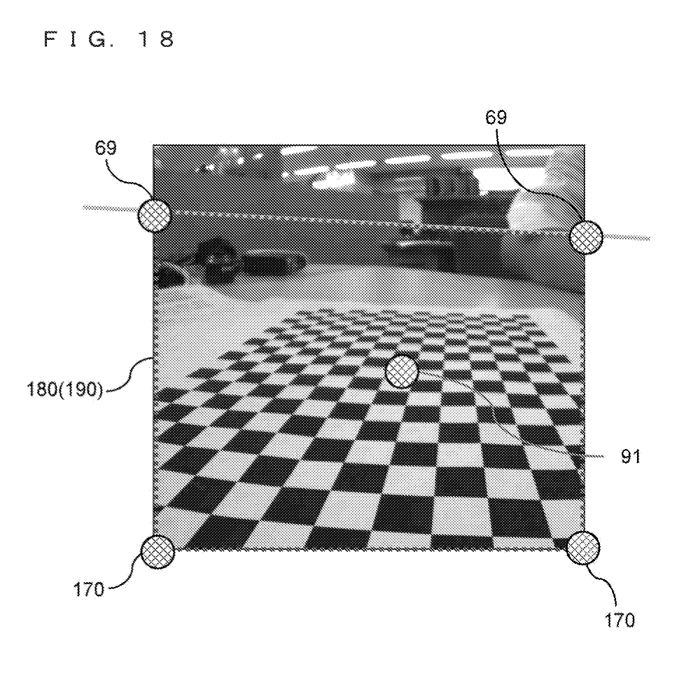

Next, the main control section 21 calculates a polygonal area formed by connecting the first intersections 69, 69 calculated in step S1403 and the second intersections 170, 170 calculated in step S1404 (step S1405). FIG. 18 is an illustrative view of a multivalued image in which a polygonal area, formed by connecting the first intersections 69, 69 and the second intersections 170, 170, has been calculated. As shown in FIG. 18, the main control section 21 calculates a multivalued area 180 formed by connecting the first intersections 69, 69 and the second intersections 170, 170. The multivalued area 180 calculated in step S1405 is a predetermined area that is set as the transformation target area 190 in step S1104.

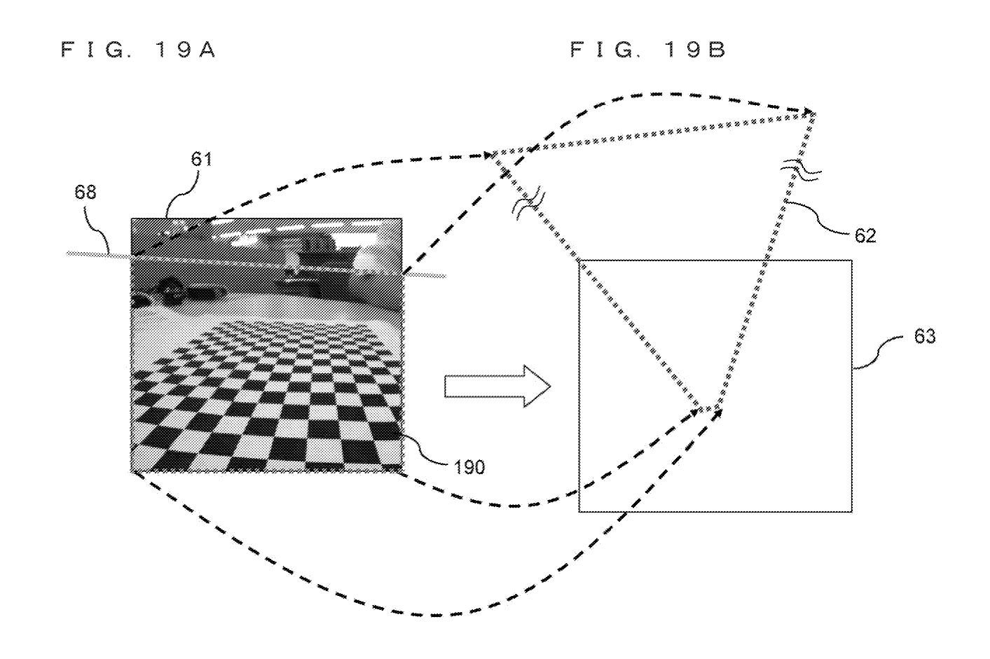

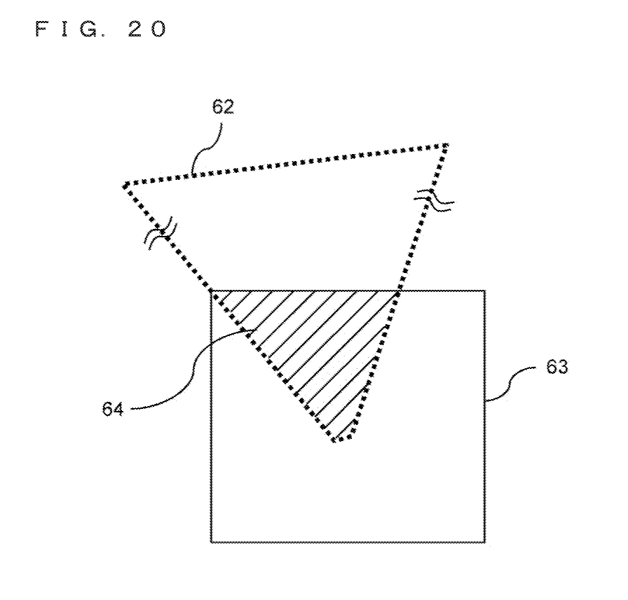

Returning to FIG. 11, in step S1105 which corresponds to step S304, based upon inverse transformation of the projection transformation matrix H, the main control section 21 calculates the projected area 62 obtained by projectively transforming the transformation target area 190, as the multivalued image before image processing set in step S1104, to the output area 63 where the pixels of the multivalued image after image processing exist. FIGS. 19A and 19B are illustrative views showing the multivalued image before image processing which has been set with the transformation target area 190, and a positional relation between the area 61 where the pixels of the multivalued image before image processing exist and the projected area 62. In FIG. 19A, the transformation target area 190 set in step S1104 is shown in the area 61 where the pixels of the multivalued image before image processing exist. In FIG. 19B, the positional relation is shown between the output area 63 where the pixels of the multivalued image after image processing exist and the projected area 62 obtained by projectively transforming the transformation target area 190 to the output area 63 where the pixels of the multivalued image after image processing exist, based upon inverse transformation of the projective transformation matrix H.

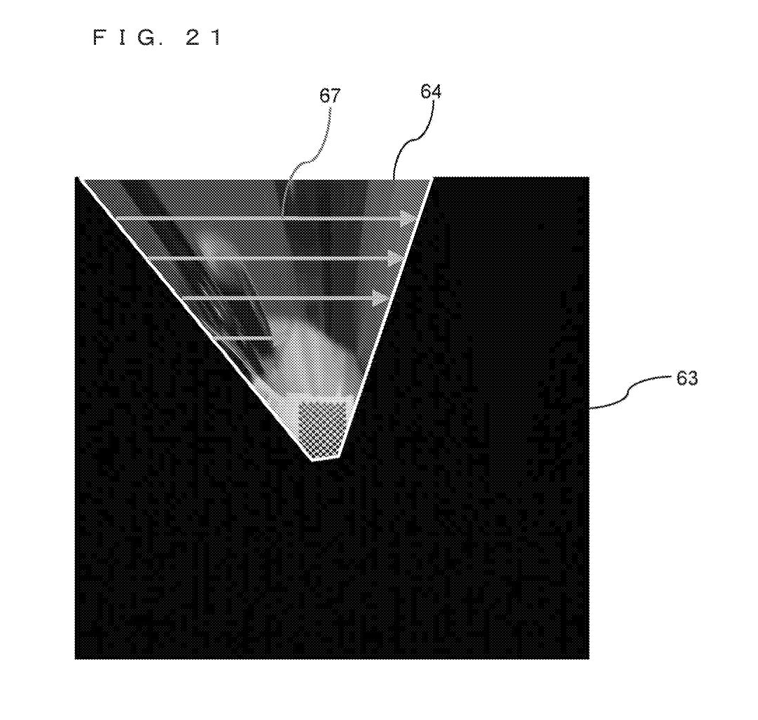

Returning to FIG. 11, in step S1106 which corresponds to step S305, the main control section 21 specifies, as the effective area, an area in which the projected area 62 calculated in step S1105 is overlapped with the output area 63 where the pixels of the multivalued image after image processing exist. FIG. 20 is an illustrative view showing a positional relation between the projected area 62 and the output area 63 where the pixels of the multivalued image after image processing exist. As shown in FIG. 20, the main control section 21 specifies, as the effective area 64, an area in which the projected area 62 is overlapped with the output area 63 where the pixels of the multivalued image after image processing exist.

Returning to FIG. 11, in step S1107 which corresponds to step S306, coordinate transformation from coordinates of the multivalued image after image processing (coordinates of transformation destination) to coordinates of the multivalued image before image processing (coordinates of transformation source) is performed based upon the projective transformation matrix, exclusively in the effective area 64 specified in step S1106. FIG. 21 is an illustrative view of a multivalued image after projective transformation. As shown in FIG. 21, in an order indicated with arrows 67, the main control section 21 sequentially obtains coordinates inside the area 61 where the pixels of the multivalued image before image processing exist which are obtained by projectively transforming coordinates of pixels existing in the effective area 64 based upon the projective transformation matrix H, to generate a multivalued image after image processing with corrected perspective distortion. It should be noted that in the second embodiment, the projective transformation matrix H, which is used for image processing to generate the multivalued image after image processing with corrected perspective distortion from the multivalued image before image processing, is not necessarily calculated based upon shape information that specifies the shapes of imaging object before image processing and after image processing. For example, calibration processing may be performed using a multivalued image obtained by picking up a calibration pattern printed with a pattern of dots at fixed intervals, thereby to calculate a projective transformation matrix.

Although the description was given in the second embodiment to the image processing steps for generating the multivalued image after image processing with corrected perspective distortion after obtainment of the effective area, image processing may be performed while specifying the effective area in the process of generating the multivalued image after image processing. In other words, the effective area may be specified by determining whether the pixels of the multivalued image after image processing exist inside or outside the projected area 62 in the process of generating the multivalued image after image processing. When the pixels of the multivalued image after image processing exist inside the projected area 62, the nearest pixel of the coordinate 66 obtained by performing projective transformation based upon the projective transformation matrix H can be taken, as it is, as the pixel 65 of the effective area 64. When the pixels exist outside the projected area 62, image processing, such as processing of setting pixel values to 0 (zero) while not performing projective transformation, may be performed.

As described above, in the image processing apparatus 2 according to the second embodiment of the present invention, in the area 61 where the pixels of the multivalued image before image processing exist, a predetermined area including pixels that exist inside the shape of the imaging object 91 specified by shape information, the input of which has been accepted by the shape information input accepting device 80, is set as a transformation target area 190. The projected area 62 is calculated which is obtained by projectively transforming the transformation target area 190 of the multivalued image before image processing to the output area 63 where the pixels of the multivalued image after image processing exist. An area is specified as the effective area 64 in which the projected area 62 is overlapped with the output area 63 where the pixels of the multivalued image after image processing exist. It is thereby possible to suppress appearance of the multivalued image 93, as an unnecessary multivalued image (virtual image) shown in FIG. 9A, in the multivalued image after image processing. Meanwhile, it is not necessary to perform projective transformation on the multivalued image 93 as the unnecessary multivalued image (virtual image) shown in FIG. 9A, and processing time can be reduced, so as to complete image processing at high speed.

Further, in the image processing apparatus 2 according to the second embodiment of the present invention, the first intersections 69, 69 are calculated at which the boundary 68 defined based upon the matrix element of inverse transformation of the projective transformation matrix H is intersected with the outer circumferential line of the area 61 where the pixels of the multivalued image before image processing exist. The second intersections 170, 170 are calculated at which the outer circumferential lines of an area are intersected with each other, the area including pixels that exist inside the shape of the imaging object 91 specified by the shape information out of the areas 61 which are divided by the boundary 68 and in which the pixels of the multivalued image before image processing exist. The polygonal area 180, formed by connecting the first intersections 69, 69 and the second intersections 170, 170, is set as the transformation target area 190. It is thereby possible to reliably suppress appearance of the multivalued image 93 as the unnecessary multivalued image (virtual image) in the multivalued image after image processing.

What is claimed is:

1. An image processing apparatus, which executes image processing on a multivalued image obtained by picking up an image of an imaging object with an imaging device, the apparatus comprising:
a projective transformation parameter calculating device for calculating a predetermined projective transformation parameter for projectively transforming a multivalued image before image processing to correct perspective distortion;
a projected area calculating device for calculating a projected area, obtained by projectively transforming an area where pixels of the multivalued image before image processing exist to an output area where pixels of a multivalued image after image processing exist, based upon the projective transformation parameter calculated by the projective transformation parameter calculating device;
an effective area specifying device for specifying as an effective area an area in which the projected area calculated by the projected area calculating device is overlapped with the output area where the pixels of the multivalued image after image processing exist; and
an image transforming device for performing coordinate transformation based upon the effective area specified by the effective area specifying device and the projective transformation parameter calculated by the projective transformation parameter calculating device, to generate the multivalued image after image processing from the multivalued image before image processing.

2. The image processing apparatus according to claim 1, comprising
a shape information input accepting device for accepting an input of shape information that specifies shapes of the imaging object before image processing and after image processing on the multivalued image, wherein
the projective transformation parameter calculating device calculates the projective transformation parameter based upon the shape information the input of which has been accepted by the shape information input accepting device.

3. The image processing apparatus according to claim 2, comprising
an image displaying device for displaying the multivalued image, wherein
the shape information input accepting device accepts the input of the shape information that specifies shapes of the imaging object before image processing and after image processing on the multivalued image before image processing displayed in the image displaying device.

4. The image processing apparatus according to claim 3, wherein the image displaying device is provided with a display switching device for switching and displaying the multivalued image before image processing, the multivalued image after image processing, and the shape information the input of which has been accepted by the shape information input accepting device.

5. The image processing apparatus according to claim 1, comprising
a transformation target area setting device for setting as a transformation target area a predetermined area including specific pixels in the area where the pixels of the multivalued image before image processing exist, wherein
the projected area calculating device calculates the projected area, obtained by projectively transforming the transformation target area set by the transformation target area setting device, based upon the projective transformation parameter calculated by the projective transformation parameter calculating device.

6. The image processing apparatus according to claim 5, wherein the transformation target area setting device sets the predetermined area including specific pixels as the transformation target area out of areas divided by a predetermined straight line defined based upon the projective transformation parameter.

7. The image processing apparatus according to claim 6, wherein the transformation target area setting device sets, as the transformation target area, a predetermined area including pixels that exist inside the shape of the imaging object, the shape being specified by the shape information the input of which has been accepted by the shape information input accepting device.

8. The image processing apparatus according to claim 7, wherein
the transformation target area setting device has:
a first intersection calculating device for calculating a first intersection at which a predetermined straight line defined based upon the projective transformation parameter is intersected with an outer circumferential line of the area where the pixels of the multivalued image before image processing exist;
a second intersection calculating device for calculating a second intersection at which outer circumferential lines of the area including pixels that exist inside the shape of the imaging object are intersected with each other out of the areas divided by the predetermined straight line, the shape being specified by the shape information the input of which has been accepted by the shape information input accepting device; and
a polygonal area calculating device for calculating a polygonal area formed by connecting the first intersections calculated by the first intersection calculating device and the second intersections calculated by the second intersection calculating device, and
the polygonal area calculated by the polygonal area calculating device is set as the transformation target area.

9. An image processing method capable of executing image processing on a multivalued image obtained by picking up an image of an imaging object with an imaging device, the method comprising the steps of:
calculating a predetermined projective transformation parameter for projectively transforming a multivalued image before image processing to correct perspective distortion;
calculating a projected area, obtained by projectively transforming an area where pixels of the multivalued image before image processing exist to an output area where pixels of a multivalued image after image processing exist, based upon the calculated projective transformation parameter;
specifying as an effective area an area in which the calculated projected area is overlapped with the output area where the pixels of the multivalued image after image processing exist; and
performing coordinate transformation based upon the specified effective area and the calculated projective transformation parameter, to generate the multivalued image after image processing from the multivalued image before image processing.

10. A computer program capable of causing an image processing apparatus to execute image processing on a multivalued image obtained by picking up an image of an imaging object with an imaging device, wherein the image processing apparatus is made to function as:
a projective transformation parameter calculating device for calculating a predetermined projective transformation parameter for projectively transforming a multivalued image before image processing to correct perspective distortion;
a projected area calculating device for calculating a projected area, obtained by projectively transforming an area where pixels of the multivalued image before image processing exist to an output area where pixels of a multivalued image after image processing exist, based upon the projective transformation parameter calculated by the projective transformation parameter calculating device;
an effective area specifying device for specifying as an effective area an area in which the projected area calculated by the projected area calculating device is overlapped with the output area where the pixels of the multivalued image after image processing exist; and
an image transforming device for performing coordinate transformation based upon the effective area specified by the effective area specifying device and the projective transformation parameter calculated by the projective transformation parameter calculating device, to generate the multivalued image after image processing from the multivalued image before image processing.

11. The computer program according to claim 10, wherein
the image processing apparatus is made to function as a shape information input accepting device for accepting an input of shape information that specifies shapes of the imaging object before image processing and after image processing on the multivalued image, and
the projective transformation parameter calculating device is made to function as a device for calculating the projective transformation parameter based upon the shape information the input of which has been accepted by the shape information input accepting device.

12. The computer program according to claim 11, wherein the shape information input accepting device is made to function as a device for accepting the input of the shape information that specifies shapes of the imaging object before image processing and after image processing on the displayed multivalued image before image processing.

13. The computer program according to claim 12, wherein the image processing apparatus is made to function as a display switching device for switching and displaying the multivalued image before image processing, the multivalued image after image processing, and the shape information the input of which has been accepted by the shape information input accepting device.

14. The computer program according to claim 10, wherein
the image processing apparatus is made to function as a transformation target area setting device for setting as a transformation target area a predetermined area including specific pixels in the area where the pixels of the multivalued image before image processing exist, and
the projected area calculating device is made to function as a device for calculating the projected area, obtained by projectively transforming the transformation target area set by the transformation target area setting device, based upon the projective transformation parameter calculated by the projective transformation parameter calculating device.

15. The computer program according to claim 14, wherein the transformation target area setting device is made to function as a device for setting the predetermined area including specific pixels as the transformation target area out of areas divided by a predetermined straight line defined based upon the projective transformation parameter.

16. The computer program according to claim 15, wherein the transformation target area setting device is made to function as a device for setting as the transformation target area a predetermined area including pixels that exist inside the shape of the imaging object, the shape being specified by the shape information the input of which has been accepted by the shape information input accepting device.

17. The computer program according to claim 16, wherein the transformation target area setting device is made to function as:
a first intersection calculating device for calculating a first intersection at which a predetermined straight line defined based upon the projective transformation parameter is intersected with an outer circumferential line of the area where the pixels of the multivalued image before image processing exist;
a second intersection calculating device for calculating a second intersection at which outer circumferential lines of the area including pixels that exist inside the shape of the imaging object are intersected with each other out of the areas divided by the predetermined straight line, the shape being specified by the shape information the input of which has been accepted by the shape information input accepting device;
a polygonal area calculating device for calculating a polygonal area formed by connecting the first intersections calculated by the first intersection calculating device and the second intersections calculated by the second intersection calculating device; and
a device for setting the polygonal area, calculated by the polygonal area calculating device, as the transformation target area.
